(19) United States
(12) Patent Application Publication
(10) Pub. No.: US 2011/0038695 A1
(43) Pub. Date: Feb. 17, 2011

(54) Goods Feeding Device

(75) Inventor: Udo Vosshenrich, Bad Salzuflen (DE)

Correspondence Address: LERNER GREENBERG STEMER LLP, P O BOX 2480, HOLLYWOOD, FL, 33022-2480, US

(73) Assignee: POS TUNING UDO VOSSHENRICH GMBH & CO. KG, Bad Salzuflen (DE)

(21) Appl. No.: 12/565,918

(22) Filed: Sep. 24, 2009

Related U.S. Application Data
(63) Continuation of application No. PCT/DE2009/001145, filed on Aug. 14, 2009.

(51) Int. Cl. B65G 1/06

(52) U.S. Cl. 414/277; 414/754

(57) ABSTRACT

The functionality and effectiveness of a goods feeding device for a front carton of a plurality of cartons or goods trays of a shelf-ready packaging system arranged one behind the other on a shelf of a display and storage rack, with goods or goods packaging stored therein, is further improved. The goods feeding device has a pusher plate for the goods on a slide housing which allows a manual rack-loading of deep commercial racks with narrow shelf spacings and a plurality of cartons or goods trays stored one behind the other is made substantially easier. This is achieved by virtue of the fact that the pusher plate is fixed in a height-adjustable manner to the slide housing and can be moved out of an erected work setting into a flattened position.

### CROSS-REFERENCE TO RELATED APPLICATION

This is a continuing application, under 35 U.S.C. §120, of copending international application No. PCT/DE2009/001145, filed Aug. 14, 2009, which designated the United States; the prior application is herewith incorporated by reference in its entirety.

### BACKGROUND OF THE INVENTION

### Field of the Invention

The invention relates to a goods feeding device, in particular for a front carton of a plurality of cartons or goods trays of a shelf-ready packaging system arranged one behind the other on a shelf of a multistoried display and storage rack with goods or goods packagings stored therein.

A goods display device for cartons or goods trays of a shelf-ready packaging system (SRP system) contains a goods slide for goods packagings stacked one behind the other on a shelf, a slide housing having a roll spring, which is mounted such that it is rolled up therein and can be drawn out therefrom, and a pusher plate. The goods display device further contains a front anchor for fixing in a front region of a shelf. On the pusher plate thereof a label holder can be mounted which allows the insertion of a goods label and enlarges the active surface of the pusher plate. Such a device is known from published, European patent application EP 1 462 035 A2.

A drawback with this configuration is that, even without the mounted label holder, the pusher plate is still of such a height that, particularly in the case of very narrow shelf spacings, a second or third carton or goods tray of the SRP system cannot easily be lifted over the goods feeding device in order to fill the rear rack regions. Nor is a two-part construction of the goods slide with a separate pusher plate very practical, since loose parts can easily get lost, whereby the goods feeding device as a whole would immediately become unusable.

### SUMMARY OF THE INVENTION

It is accordingly an object of the invention to provide a goods feeding device which overcomes the above-mentioned disadvantages of the prior art devices of this general type. The object of the invention relates to further improving the functionality and effectiveness of the goods feeding device and in substantially facilitating a manual rack-loading, in particular of deep commercial racks with narrow shelf spacings, with a plurality of cartons or goods trays of the SRP system stored one behind the other.

With the foregoing and other objects in view there is provided, in accordance with the invention a goods feeding device. The goods feeding device contains a slide housing and a pusher plate for goods on the slide housing. The pusher plate is fixed in a height-adjustable manner to the slide housing and can be moved out of an erected work setting into a flattened position.

The object is achieved according to the invention by virtue of the fact that the pusher plate is fixed in a height-adjustable manner to the slide housing of the goods slide, whereby the pusher plate can be moved out of an erected or raised, high work setting into a flattened, low servicing position.

Such a construction allows the height of the goods feeding device to be briefly lowered, say, to the height of the slide housing, so that stock cartons or trays to be passed over it rearward onto a shelf can be stowed very much more easily into a rack. A further fundamental advantage consists in the fact that the inventive configuration of the goods feeding device allows the above-situated shelves to be arranged substantially closer together, so that the capacity of a rack can be markedly increased. The movable securement of the pusher plate to the slide housing ensures, moreover, that it cannot accidentally get lost, whereby the working of the goods feeding device is perpetually assured.

In accordance with a particularly preferred embodiment of the subject of the invention, the pusher plate is arranged on the slide housing such that it is pivotable and/or telescopable at least about one axis, so that it can be pivoted or twisted to left or right, forward or rearward, or else can be pushed telescopically downward, whereby the pusher plate can be brought, say, level with the upper end surface of the slide housing.

Particularly advantageous is an embodiment in which the axis is arranged horizontally and at right angles to the motional direction of the goods slide, in particular level with the top edge of the slide housing, so that the upper part of the axially divided pusher plate can be pivoted forward or rearward. The axis could also conceivably be arranged in the lower region of the slide housing, so that the pusher plate, over a large area, could be tilted forward, while an arrangement of the axis horizontally and along the motional direction of the goods slide would also be possible, whereby a lateral deflection of the pusher plate to left or right could be enabled, though, in the case of very narrow goods and thus narrow cartons, the lateral clearance necessary for this might not be available.

According to a particularly advantageous embodiment of the invention, the axis is configured as a film hinge or as some other simple joint construction, so that the complexity of production of the plastic-made goods slide housing is kept within narrow limits and the working of the flattening of the pusher plate is assured over the service life of the goods feeding device without the joint of the axis requiring any type of care or maintenance. The arrangement of the axis in the region of the top edge of the slide housing has a further fundamental advantage, since the rear side of the pusher plate can then be used to shape it, by virtue of the configuration containing at least one or more arc-shaped runners, such that stock cartons or goods trays which are to be passed over the flattened goods slide rearward into a rack can slide over these arc-shaped runners. At the same time, a lower edge of a stock carton to be shelved is reliably prevented from catching on or bumping into an edge of the goods slide.

Preferably, the runners are configured such that, in the upright state of the upper part of the pusher plate, they extend over the pivot axis by the side of the slide housing down to behind the fixed part of the pusher plate and are supported there and, in the flattened state of the pusher plate, are raised over this into the end region of the slide housing.

This increases, on the one hand, the stability of the pusher plate and, on the other hand, the quality of the sliding function, and protects the slide housing from mechanical load.

Also advantageous is a configuration of the front anchor containing a bearing surface or, indeed, a catch for the upper margin of a pusher plate situated in the tilted state, so that the weight of a stock carton which may be briefly deposited onto the goods slide as a rack is filled, not only has to be absorbed by the film hinge, but is diverted via the front anchor into the shelf. The forward tilted pusher plate can be kept tightened by the roll spring also forward into a catch in the front anchor, so that an unwanted erection of the pusher plate as a rack is filled can be reliably prevented.

A further advantageous refinement of the inventive goods feeding device has a front anchor having a connecting piece for a guide profile of the goods slide, which connecting piece is lowered relative to the structural height of the guide profile, so that a carton placed into the goods feeding device is held with a front, transversely running carton strip in the bottom region, engaged there between the front anchor and the guide profile.

Also advantageous is an embodiment of the goods feeding device in which the guide profile has a structural height exceeding the thickness measurement of the carton bottom, so that the goods item, following the introduction of the carton belonging to the SRP system and provided with a bottom and a rear slot, no longer stands on the carton bottom, but on the guide profile, which additionally, on its supporting surface, can be provided with an antifriction coating, thereby further substantially increasing the functional reliability of the goods feeding device and minimizing the necessary feed force. This ensures that, when a front pack is removed, the joint withdrawal of a further pack from the tray or of packs standing in front of a tray, due to high contact pressure of the goods feed, is precluded. The feed force can be chosen sufficiently small that the generated friction forces between the goods packagings are less than the gravitational force of the products. Furthermore, a reduced feed force makes the filling of a rack easier.

Other features which are considered as characteristic for the invention are set forth in the appended claims.

Although the invention is illustrated and described herein as embodied in a goods feeding device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a goods feeding device with an upright pusher plate according to the invention;

FIG. 2 is a perspective view of the goods feeding device according to FIG. 1, with a flattened pusher plate;

FIG. 3 is a side view of the subject of FIG. 2;

FIG. 4 is a partial view of a rack;

FIG. 5 is a perspective view from diagonally below of a goods tray mounted on the goods feeding device; and

FIG. 6 is a perspective view from diagonally above of the device according to FIG. 5 mounted on a shelf.

### DETAILED DESCRIPTION OF THE INVENTION

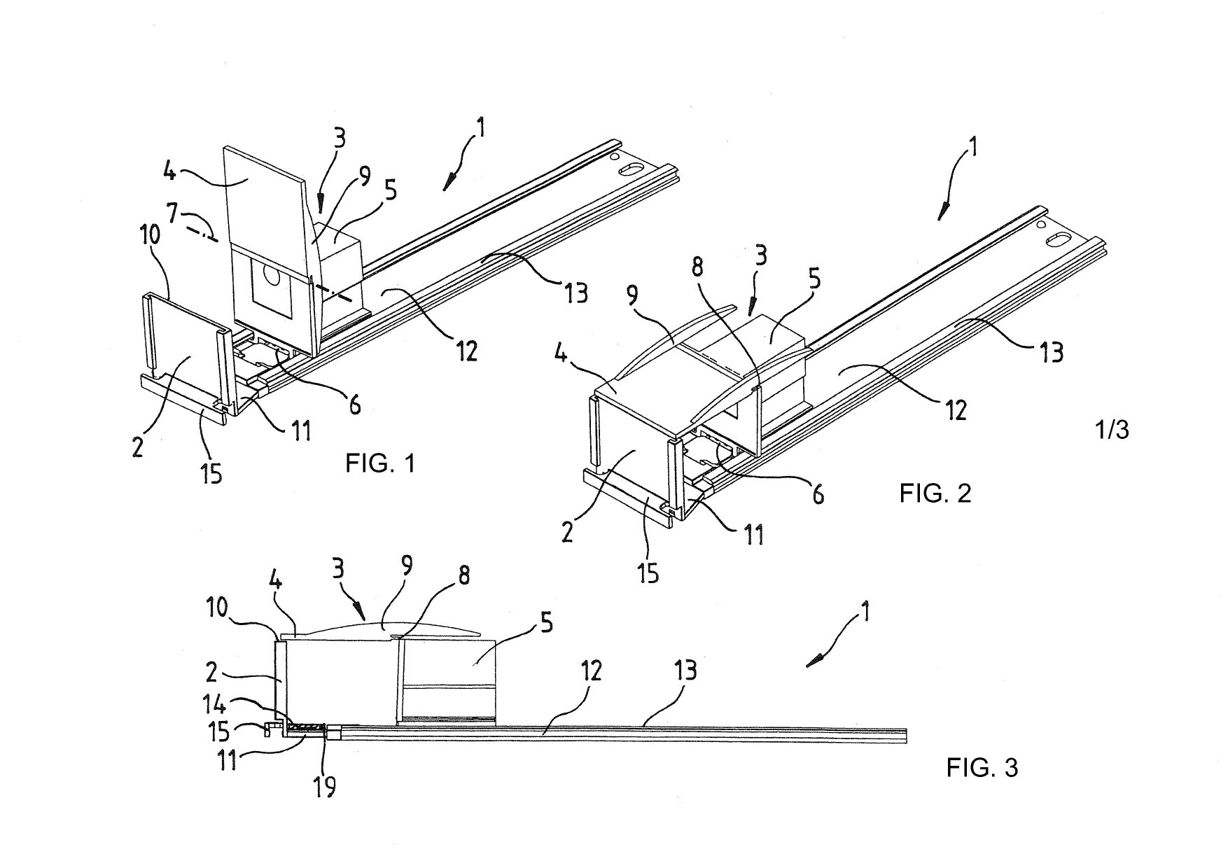

Referring now to the figures of the drawing in detail and first, particularly, to FIG. 1 thereof, there is shown a goods feeding device 1 that includes a goods slide 3, which in turn has a horizontally divided pusher plate 4. An upper part of the pusher plate 4 is articulately attached to the slide housing 5 pivotably about an axis 7, the axis 7 being configured as a film hinge 8. Embodiments having standard joint constructions are likewise possible, but are not diagrammatically represented. The goods feeding device 1 also incorporates a front anchor 2, which on the front side is connected by a connecting piece 11 to a guide profile 12, in which the slide housing 5 is guided. Mounted rolled-up in the slide housing 5 is a roll spring 6, the front end of which is fixed to the front anchor 2. The front anchor 2 has a clip fastening 15 for adaptation systems such as, say, for a clamping rail 22.

The connecting piece 11 has a lesser height than the guide profile 12, so that in the bottom region 14 of a carton/goods tray 18 of a shelf-ready packaging system, which goods tray is to be placed into the goods feeding device 1, the front bottom region thereof can engage there in a form-locking manner. The guide profile 12 itself also has a height exceeding the thickness measurement of a carton 18, so that, when a carton 18 provided with a bottom and back cutout 23 is put on, the goods 20 stored therein stand vertically on the guide profile 12, the supporting surface 13 being provided with an antifriction coating.

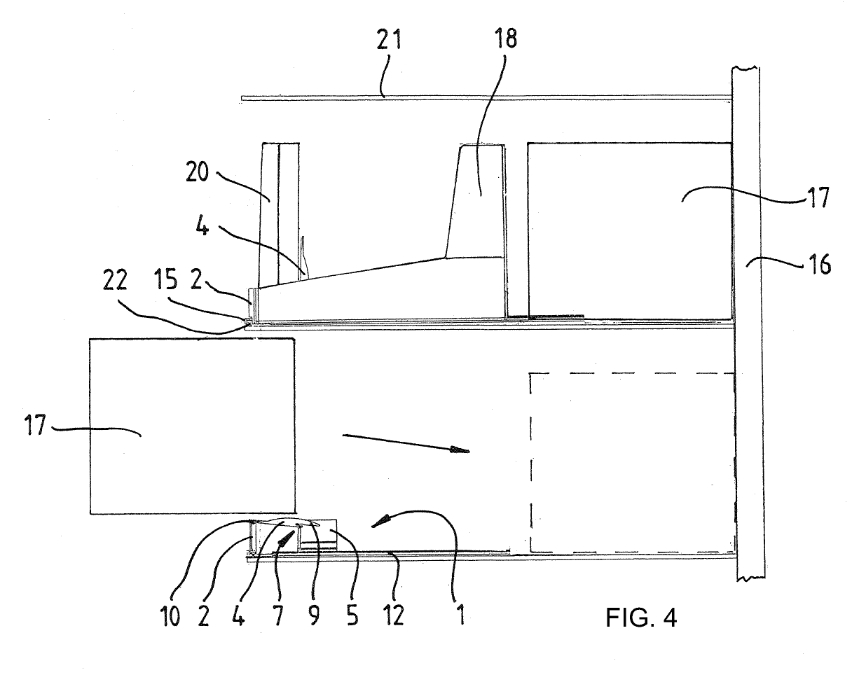

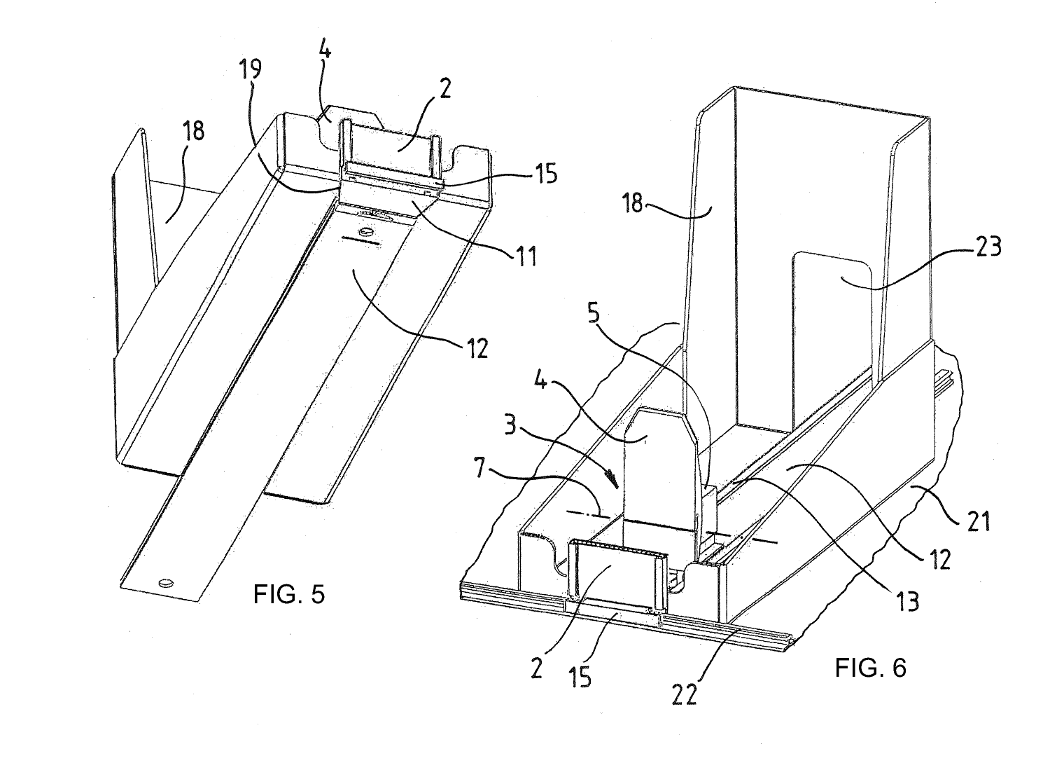

The pusher plate 4 can be pivoted, such as out of an upright position represented in FIGS. 1, 4 (top), 5 and 6, into a flattened position as represented in FIGS. 2, 3 and 4 (bottom), the upper margin of the pusher plate 4 resting on a bearing surface 10 of the front anchor 2. On the rearward-facing back of the pusher plate 4 or, in the flattened state of the goods feeding device 1, upward-facing back of the pusher plate 4, arc-shaped runners 9 are arranged on both sides, which make it easier for a shelf 21 to be filled, over the goods slide 3, with one or more stock cartons 17, and prevent an accidental canting or catching of a front carton edge on the goods slide 3. The runners 9 are extended from the back of the upper part of the pusher plate 4 such that, in their upright position, they bear on both sides of the slide housing 5 against the back of the fixed part of the pusher plate 4 and are supported there and, in the flattened state of the pusher plate 4, ensure that a carton 18 is guided to, say, over the slide housing 5, as represented diagrammatically in FIG. 4 (bottom).

1. A goods feeding device, comprising:
a slide housing;
a pusher plate for goods on said slide housing, said pusher plate being fixed in a height-adjustable manner to said slide housing and can be moved out of an erected work setting into a flattened position, said slide housing and said pusher plate defining a goods slide;
a guide profile for said goods slide; and
a front anchor having one of a bearing surface and a catch for said pusher plate situated in a tilted state, said front anchor further having a connecting piece connected to said guide profile for said goods slide, said connecting piece being lowered relative to a structural height of said guide profile, and a carton placed into the goods feeding device is held with a front carton strip in a bottom region, engaged there between said front anchor and said guide profile.

2. The goods feeding device according to claim 1, wherein said pusher plate is disposed on said slide housing such that it is at least one of pivotable and telescopable about at least one axis.

3. The goods feeding device according to claim 2, wherein said axis lies horizontally and at right angles to a motional direction of said goods slide.

4. The goods feeding device according to claim 3, wherein said axis is arranged level with a top side of said slide housing and said pusher plate is horizontally divided along said axis and has an upper part that can be pivoted forward or rearward.

5. The goods feeding device according to claim 4, further comprising one of a film hinge and some other joint defining said axis.

6. The goods feeding device according to claim 4, wherein said pusher plate is a forward-tiltable pusher plate and a back of said upper part of said forward-tiltable pusher plate has at least one arc-shaped runner for a stock carton of a shelf-ready packaging system, the stock carton to be passed over said goods slide rearward into a rack.

7. The goods feeding device according to claim 6, wherein in an upright state of said pusher plate, said arc-shaped runner extends over said axis alongside said slide housing down to behind a fixed part of said pusher plate and is supported there and, in the flattened state, is raised over said pusher plate into an end region of said slide housing.

8. (canceled)

9. (canceled)

10. The goods feeding device according to claim 1, wherein said structural height of said guide profile exceeds a thickness measurement of a carton bottom, and in that the goods, when a carton of a shelf-ready packaging system, which carton is provided with an appropriate bottom and back cutout, is in a state of having been placed into the goods feeding device, stands vertically on said guide profile.

11. The goods feeding device according to claim 10, wherein said guide profile has a supporting surface for supporting the goods, said supporting surface having an antifriction coating.

12. The goods feeding device according to claim 1, wherein the goods feeding device is for a front carton of a plurality of cartons or goods trays of a shelf-ready packaging system disposed one behind the other on a shelf of a multistoried display and storage rack, with the goods or goods packagings stored therein.
